(19) United States
(12) Patent Application Publication
(10) Pub. No.: US 2004/0052576 A1
(43) Pub. Date: Mar. 18, 2004

(54) Apparatus for optimizing the attachment of a hub structure to an axle

(76) Inventor: Robert Snow, San Jose, CA (US)

Correspondence Address: Alex Sousa, IPSG, P.C., P.O. Box 61147, Sunnyvale, CA, 94088, US

(21) Appl. No.: 10/246,506

(22) Filed: Sep. 18, 2002

(51) Int. Cl. F16B 7/18

(52) U.S. Cl. 403/300

(57) ABSTRACT

The invention relates, in one embodiment, to a clamp assembly for attaching a hub structure to an axle. The clamp assembly includes a tubular structure having a longitudinal axis. The clamp assembly also includes a hub attachment mechanism and an axle clamping mechanism. The axle clamping mechanism includes an expansion slot and a clamping fastener. And the expansion slot includes a neutral position, a compression range, and an expansion range. When the clamping fastener is moved in a first lateral direction, the clamping fastener compresses the expansion slot to a position in the compression range. When the clamping fastener is moved in a second lateral direction by a first amount allows, the expansion slot is allowed to expand back to the neutral position. And, any movement thereafter expands expands the expansion slot to a position in the expansion range.

### FIELD

The present invention relates in general to motorized land vehicles, and in particular to apparatus for optimizing the attachment of a hub structure to an axle.

### BACKGROUND OF THE INVENTION

Stability and traction are important for motorized land vehicles. Stability is the vehicle's tendency to resist inertia force during a change the magnitude or direction of motion. Traction is the vehicle's tendency to grip the surface upon which it moves. Both affect performance and safety. Without sufficient stability and traction, a vehicle may spinout or tip over, causing damage and injury.

Although stability can be controlled by the vehicle driver through skilled acceleration, braking, and steering, traction can be substantially controlled through vehicle configuration. That is, by proper vehicle weight distribution, or more specifically, by the position of the vehicle's center of gravity (CG) relative to the ground. CG is a virtual point through which inertial forces appear to act on the vehicle. Adjusting the CG closer to the ground tends to improve the vehicle's traction, and hence reduce the driver skill required to maintain stability. Excess traction, however, may cause the vehicle to have poor performance, and maneuver sluggishly.

A common way to influence CG, and hence the resulting traction, is to adjust the size of the wheelbase. Wheel base may be measured as the distance on the rear axel from one tire to another. Widening the wheelbase increases traction, while narrowing it reduces it. The proper wheelbase setting can empirically determined by first observing vehicle performance and driver skill, and then adjusting the wheelbase appropriately. The ability to quickly modify the wheelbase is advantageous in many situations, particularly when the vehicle is used for racing competition, such as in go-cart racing.

Originally a recreational pass time, go-cart racing has become an almost semi-professional sport with organized teams and expensive stylized go-carts. Go-carts often achieve speeds of 75 MPH over the course of several laps. Racing organizations, such as Allkart International, hold go-cart races year-round on dedicated tracks made of dirt, clay, macadam, asphalt or concrete materials.

The typical racing go-cart is a relatively simple motorized vehicle large enough to accommodate only one individual, consisting of a tubular frame with a generally single-cylinder engine, without the differential gear and suspensions. A go-cart frame is usually formed from segments of steel tubing rigidly welded together, and the rear axle is connected to this frame by means of rigid bearing hangers.

In the discussions that follow, the term “tighten” is employed herein to discuss moving a fastener into a securing structure. Likewise, the term “loosen” is employed herein to discuss moving a fastener out of a securing structure. Furthermore, the term screw should be understood to apply to other types of fasteners, such as bolts, clips, and pins.

FIG. 1 illustrates a simplified diagram of a go-cart chassis 100. Front axle 110, is normally comprised of a fixed width wheelbase, and provides a steering mechanism for the vehicle. That is, wheels 112a-b rotate left or right in response to corresponding movements in steering column 114. Rear axle 104 is often connected to an engine, through a drive chain or belt. Rear wheels 106a-b are commonly attached to rear axle 104 through some type of clamp assembly 102a-b. In a common method, clamp assembly 102 securely clamps the wheel hub of wheel 106 to a position along axle 104. During a race, this wheel hub position can be adjusted, modifying the wheel base.

FIG. 2 illustrates a simplified diagram of a clamp assembly 200. The hub of wheel 106, shown in FIG. 1, is commonly attached to the hub by a fastener, such as a lug, bolt, or screw, through a hub attachment mechanism, such as flanges 208a-b. Axle 104, also shown in FIG. 1, is commonly inserted through end 204, sliding into the clamp assembly clamping cavity. The diameter of the clamping cavity is commonly 1/1000^{th} of an inch larger in size than the diameter of the axle for which it has been designed. Clamp assembly 200 further comprises an expansion slot 206, which allows the compression of clamp assembly 200 around the axle. Normal to expansion slot 206 is clamping screw 202. By tightening clamping screw 202, expansion slot 206 is compressed from a neutral point to a point in the compression range of the expansion slot, reducing the diameter of the clamp assembly clamping cavity, and subsequently securing it around axle 104, as shown in FIG. 1.

FIGS. 3A-B illustrate simplified diagrams of expansion slot 206 cavity. It should be noted that in FIGS. 3A-B, the relative positions of clamp assembly components, as well as the degree of expansion slot wall bending, are not necessarily drawn to scale. FIG. 3A illustrates a clamping screw 302 and the expansion slot 303 in a neutral position wherein the walls of the cavity are substantially parallel. In this position, the clamp assembly is not compressed around an axle, and so can freely slide. FIG. 3B illustrates a clamping screw 302 and the cavity 303, wherein clamping screw 302 has been tightened by an amount 308 to a compression position, wherein the walls of the expansion slot bend toward each other, compressing the hub attachment structure, and allowing it to be secured to an axle.

In practice, however, the current clamp assembly is difficult to quickly adjust in a safe manner, without damage occurring to the clamp assembly, and without the use of multiple tools. It is common for the diameter of the clamp assembly clamping cavity to be about 1/1000^{th} inch larger than the axle it surrounds. During a race, the ambient temperature around the axle may be sufficiently high to cause it to expand outward toward the hub attachment structure, substantially reducing the 1/1000^{th} inch clearance gap, and effectively binding one body to the other. Furthermore, foreign material, such as dirt particles, mud, or small rocks may have become logged in the cavity between the clamp assembly and the axle. This foreign material can create excessive friction between the inside surface of the cavity and the outer surface of the axle, again effectively binding one body to the other.

Loosening a clamp assembly that is clamped to an axle commonly requires at least three separate tools: a hammer, a wedge, and a wrench. The screw would first be loosened with the wrench. The wedge would then be placed in the expansion slot and struck with the hammer, causing the expansion slot to expand beyond the neutral position into a position in its expansion range, at which time the clamp assembly is substantially free of the axle.

However, since the clamp assembly is commonly made of machined aluminum, striking it with a hammer and wedge can cause aesthetic damage to the clamp assembly's outer surface, impacting the general stylized appearance of the go-cart. It also can over-stress the hub attachment structure's structural integrity, substantially reducing its useful life. Furthermore, since adjustments are usually done quickly, the use of a hammer to strike a wedge can substantially increase the risk of injury.

In view of the foregoing, there is desired an apparatus for optimizing the attachment of a hub structure to an axle.

### SUMMARY OF THE INVENTION

These and other features of the present invention will be described in more detail below in the detailed description of the invention and in conjunction with the following figures.

The invention relates, in one embodiment, to a clamp assembly for attaching a hub structure to an axle. The clamp assembly includes a tubular structure having a longitudinal axis. The clamp assembly also includes a hub attachment mechanism and an axle clamping mechanism. The axle clamping mechanism includes an expansion slot and a clamping fastener. And the expansion slot includes a neutral position, a compression range, and an expansion range.

When the clamping fastener is moved in a first lateral direction, the clamping fastener compresses the expansion slot to a position in the compression range.

When the clamping fastener is moved in a second lateral direction by a first amount allows, the expansion slot is allowed to expand back to the neutral position. And, any movement thereafter expands the expansion slot to a position in the expansion range.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a simplified diagram of a go-cart chassis;

FIG. 2 illustrates a simplified diagram of a tubular clamp assembly;

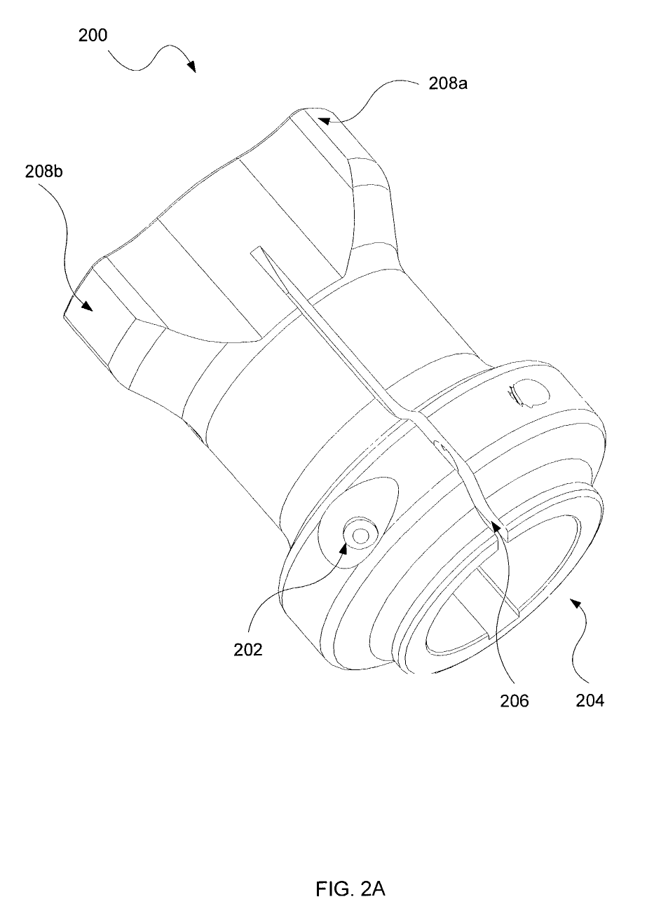

FIGS. 3A-B illustrate simplified diagrams of an expansion slot;

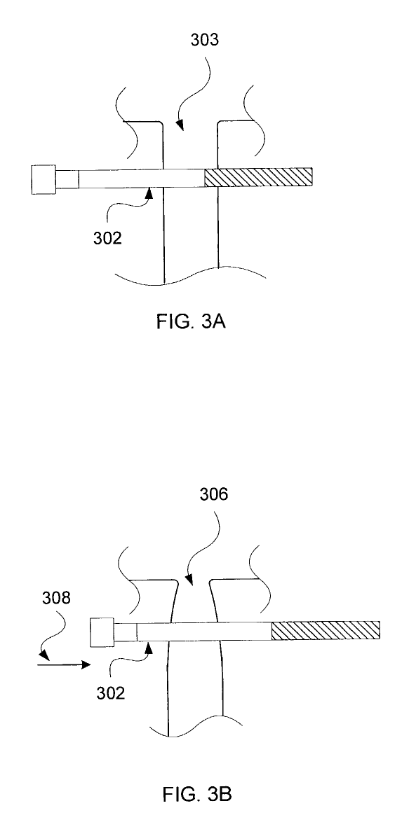

FIG. 4A illustrates a simplified diagram of a tubular clamp assembly, with the addition of a stopping screw, according to an embodiment of the invention;

FIG. 4B illustrates a simplified diagram of a clamping screw and a stopping screw, according to an embodiment of the invention;

FIGS. 5A-C illustrate simplified diagrams of the expansion slot according to an embodiment of the invention;

FIG. 6 illustrates a simplified clamping screw with a stopping ring, according to an embodiment of the invention; and,

FIGS. 7A-C illustrate simplified diagrams of the expansion slot with a clamping screw and stopping ring, according to an embodiment of the invention.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

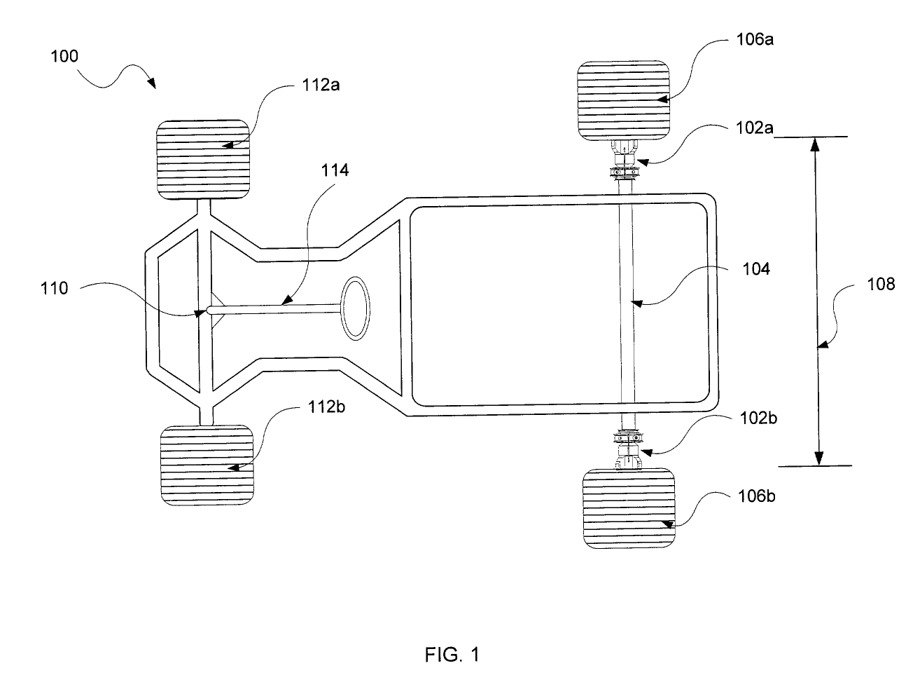

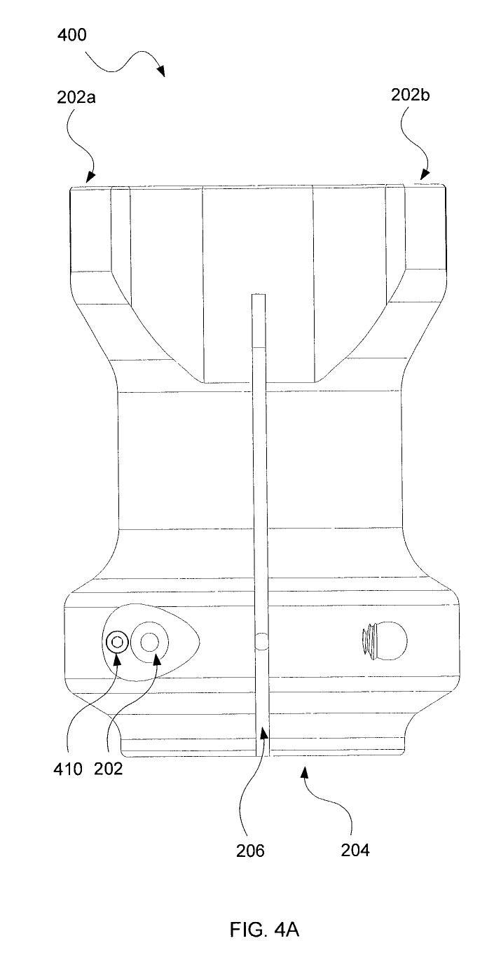

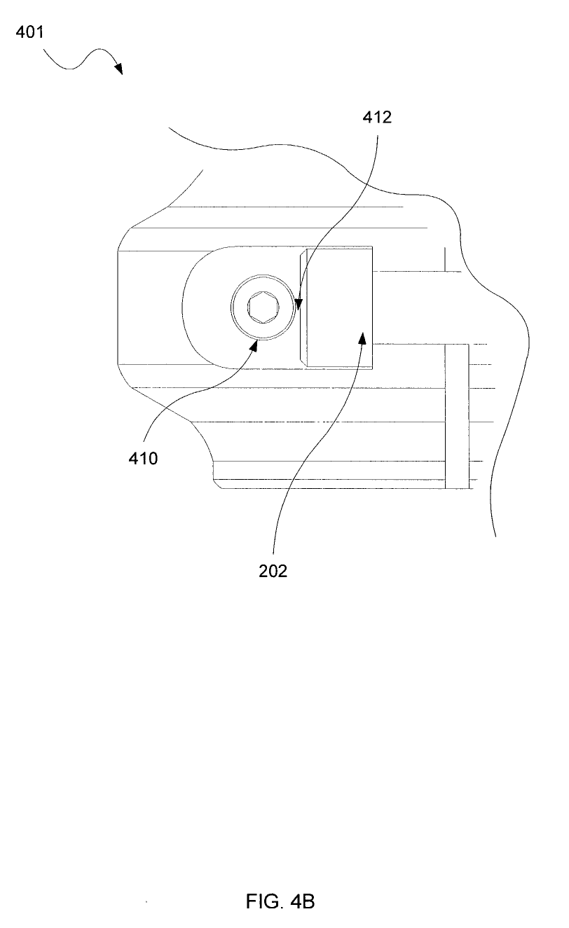

In accordance with one aspect of the invention, a stopping screw is advantageously employed in the clamp assembly to facilitate expansion of the expansion slot. Referring now to FIG. 4A, a simplified tubular clamp assembly 400 is shown with the addition of a stopping screw 410. The hub of wheel 106, shown in FIG. 1, is commonly attached to the clamp assembly 400 by a fastener, such as a lug, bolt, or screw, through a hub attachment mechanism, such as flanges 208a-b. Axle 104, also shown in FIG. 1, is commonly inserted through end 204, sliding into the clamp assembly clamping cavity. The diameter of the clamping cavity is normally 1/1000^{th} of an inch larger in size than the diameter of the axle for which it has been designed. Clamp assembly 200 further comprises an expansion slot 206, which allows the compression of clamp assembly 200 around the axle at the proper position. Normal to expansion slot 206 is a clamping screw 202. By tightening clamping screw 202, expansion slot 206 is compressed from a neutral point to a point in its compression range, reducing the diameter of the clamp assembly cavity, and subsequently securing it the around axle 104.

In order to expand expansion slot 206 to a neutral position, the process is reversed by loosening the clamping screw. However, further expansion may be necessary to accommodate axle expansion, or lodged foreign material in the clamp assembly clamping cavity 204.

Unlike current hub attachment structures which may necessitate the use of a wedge and hammer in order to become free of the axle, the current invention uses clamping screw 202 itself in combination with stopping screw 410 in order further expand the expansion slot 206 from the neutral point to a point in its expansion range, sufficient to free the clamp assembly from the axle.

In this embodiment, stopping screw 410 is positioned substantially normal to both clamping screw 202 and expansion slot 206. While expansion slot 206 is at a neutral point, or at a point in the compression range, there is no substantial contact between clamping screw 202 and stopping screw 410. As expansion slot 206 enters the expansion range through the further loosening of clamping screw 202, it comes into contact with the head of stopping screw 410. This restricts further lateral movement of clamping screw 202 toward stopping screw 404. Further loosening of clamping screw 202 instead causes expansion slot 206 to expand in a lateral direction away from stopping screw 404 and into the expansion slot expansion range. This increases the diameter of the clamp assembly cavity 204, and subsequently frees it from axle 104.

Referring now to FIG. 4B, clamping screw 202 and stopping screw 410 of FIG. 4A are shown in greater detail. In this diagram, clamping screw 202 is shown in a position relative to stopping screw 404 corresponding to the neutral point of expansion slot 206, as shown if FIG. 4A. In this position there is a small gap 412, allowing clamping screw 202 to freely rotate. Further loosening of clamping screw 202, will bring it into contact with stopping screw 404, restricting further lateral movement of clamping screw 202, and causing expansion slot 206 to expand in a lateral direction away from stopping screw 404 and into the expansion range of the expansion slot. As in FIG. 4A, this would increase the diameter of the clamp assembly cavity 204, and substantially free it from axle 104.

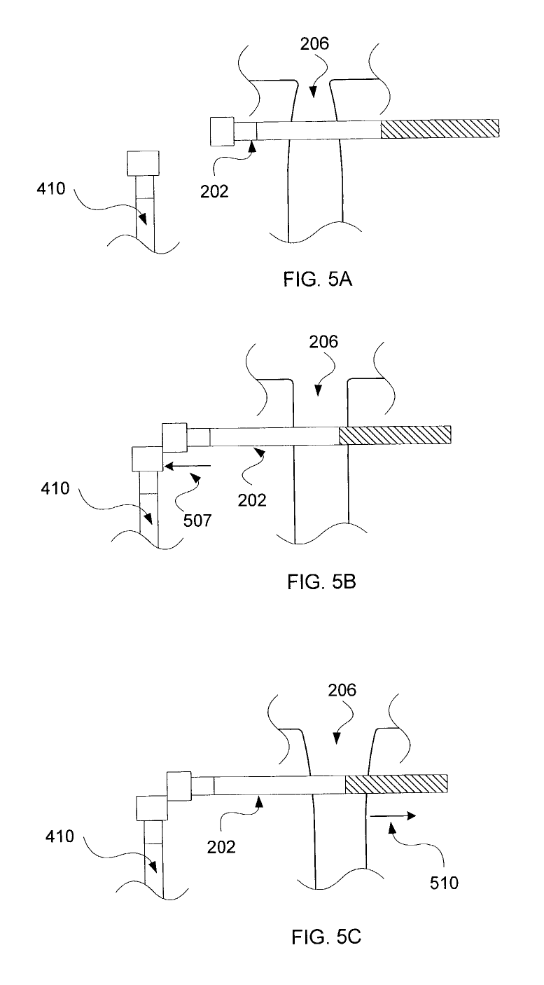

Referring now to FIGS. 5A-C, in accordance with another aspect of the invention, simplified diagrams of the expansion slot 206 are shown. It should be noted that in FIGS. 5A-C, the relative positions of clamp assembly components, as well as the degree of expansion slot wall bending, are not necessarily drawn to scale.

FIG. 5A illustrates clamping screw 202, expansion slot 206, and stopping screw 410, wherein clamping screw 202 has been tightened to cause expansion slot 206 to be at a point in the compression range. In this position, clamping screw 202 has no substantial contact with stopping screw 41 0. The walls of expansion slot 206 bend toward each other, compressing the hub attachment structure.

FIG. 5B illustrates clamping screw 202, expansion slot 206, and stopping screw 410, wherein clamping screw 202 is loosened in lateral direction 507, causing expansion slot 206 to expand to a neutral position. Again, at this position, there is no substantial contact between clamping screw 202 and stopping screw 410, although any further loosening of clamping screw 202 would cause clamping screw 202 to come into substantial contact with stopping screw 410. In the neutral position, the walls of expansion slot 206 are substantially parallel.

FIG. 5C illustrates clamping screw 202, expansion slot 206, and stopping screw 410, wherein clamping screw 202 is loosened further to cause expansion slot 206 to be at a point in the expansion range. Clamping screw 202 is restricted from further lateral movement in direction 507, as shown in FIG. 5B, by contact with stopping screw 410. Instead further loosening of clamping screw 202 causes expansion slot 206 to expand in a lateral direction 510 away from stopping screw 404 and into the expansion range. This increases the diameter of the clamp assembly cavity 204, as shown in FIG. 4A, and substantially frees it from axle 104, as shown in FIG. 1.

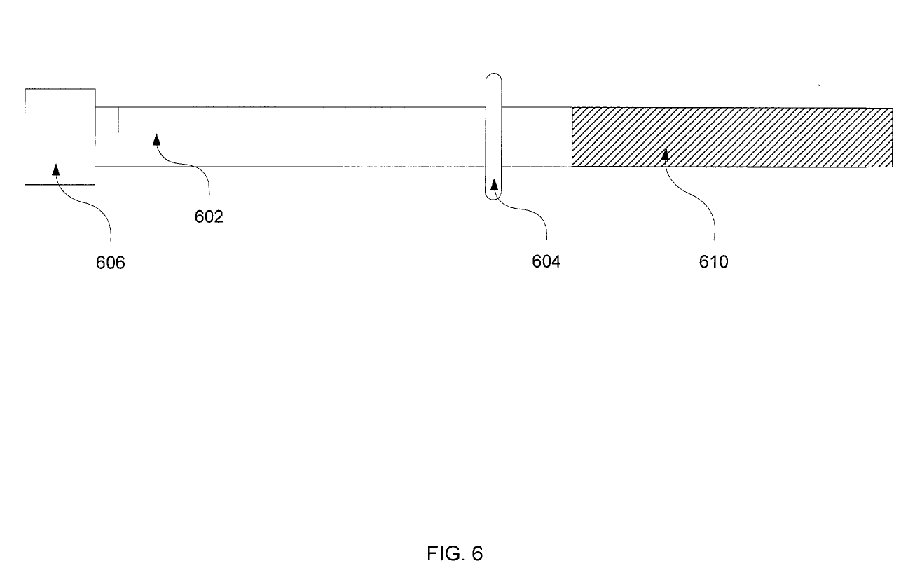

In another embodiment of the present invention, a stopping ring is advantageously employed in the clamp assembly to facilitate expansion of the expansion slot. Referring now to FIG. 6, a simplified clamping screw 602 is illustrated, wherein a stopping ring 604 is positioned between the ends of clamping screw 602, at a point between head 606 and threads 610. While expansion slot 206, shown in FIG. 4A, is at a neutral point, or at a point in the compression range, there is no substantial contact between clamping ring 604 and the walls of expansion slot 206. As clamping screw 602 is further loosened, stopping ring 604 comes into contact with one of the walls of expansion slot 206, restricting its further lateral movement, and causing expansion to expand into the expansion range.

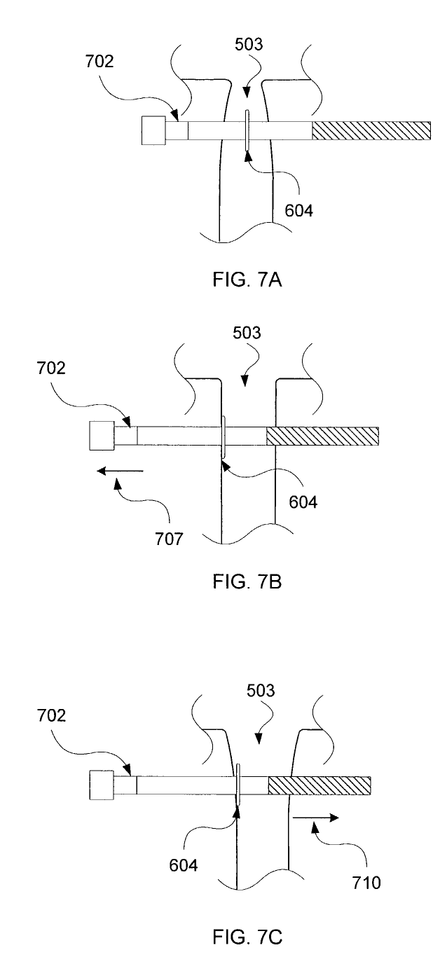

Referring now to FIGS. 7A-C, in accordance with another aspect of the invention, simplified diagrams of the expansion slot 206 are shown. It should be noted that in FIGS. 7A-C, the relative positions of clamp assembly components, as well as the degree of expansion slot wall bending, are not necessarily drawn to scale.

FIG. 7A illustrates clamping screw 702, expansion slot 206, and stopping ring 604, wherein clamping screw 702 has been tightened to cause expansion slot 206 to be at a point in the compression range. In this position, clamping screw 702 has no substantial contact with stopping ring 604. The walls of expansion slot 206 bend toward each other, compressing the hub attachment structure.

FIG. 7B illustrates clamping screw 702, expansion slot 206, and stopping ring 604, wherein clamping screw 702 is loosened to cause expansion slot 206 to a neutral position in a lateral direction 707. Again, at this position, there is no substantial contact between clamping screw 702 and stopping ring 604, although further loosening of clamping screw 702 would cause it to come into contact with stopping ring 604. The walls of expansion slot 206 are substantially parallel.

FIG. 7C illustrates clamping screw 702, expansion slot 206, and stopping ring 604, wherein clamping screw 702 is loosened further to cause expansion slot 206 to be at a point in the expansion range. Clamping screw 202 is restricted from further lateral movement by the contact of stopping ring 604 the wall of expansion slot 206. Instead further loosening of clamping screw 702 causes expansion slot 206 to expand in a lateral direction 710 away opposite to the previous lateral direction 707, of FIG. 7B, and into the expansion range. This increases the diameter of the clamp assembly cavity 204, as shown in FIG. 4A, and substantially frees it from axle 104.

While this invention has been described in terms of several preferred embodiments, there are alterations, permutations, and equivalents which fall within the scope of this invention. For example, although the drawings are described in the context of a go-cart, it should be understood that the invention also applies to other hub and axle structures, as well as to non-tubular clamping assemblies. Furthermore, the term screw should be understood to apply to other types of fasteners, such as bolts, clips, and pins. It should also be noted that there are many alternative ways of implementing the apparatuses of the present invention. It is therefore intended that the following appended claims be interpreted as including all such alterations, permutations, and equivalents as fall within the true spirit and scope of the present invention.

Advantages of the invention include the ability to loosen a clamp assembly from an axle, in a rapid and safe manner, and with a single tool. Additional advantages of the invention include reducing aesthetic damage to the hub attachment structure, and extending its useful life.

Having disclosed exemplary embodiments and the best mode, modifications and variations may be made to the disclosed embodiments while remaining within the subject and spirit of the invention as defined by the following claims.

What is claimed is:

1. A clamp assembly for attaching a hub structure to an axle, comprising:
a tubular structure having a longitudinal axis;
a first end thereof comprising a hub attachment mechanism;
a second end thereof comprising an axle clamping mechanism;
said axle clamping mechanism further comprising an expansion slot and a clamping fastener, said expansion slot including a neutral position, a compression range, and an expansion range;
wherein moving said clamping fastener in a first lateral direction compresses said expansion slot to a position in said compression range; and,
wherein moving said clamping fastener in a second lateral direction by a first amount allows said expansion slot to expand back to said neutral position, and moving said clamping fastener thereafter expands said expansion slot to a position in said expansion range.

2. The clamp assembly of claim 1, wherein said clamping fastener is a coupler.

3. The clamp assembly of claim 1, wherein said clamping fastener is an anchor.

4. The clamp assembly of claim 1, wherein said clamping fastener is a bolt.

5. The clamp assembly of claim 1, wherein said clamping fastener is a screw.

6. The clamp assembly of claim 1, wherein said clamping fastener is a pin.

7. The clamp assembly of claim 1, wherein said clamping fastener is a rivet.

8. The clamp assembly of claim 1, wherein said clamping mechanism further comprises a stopping structure that is normal to said clamping fastener, said stopping structure restricting the lateral movement of said clamping fastener beyond said neutral position to a position in said expansion range.

9. The clamp assembly of claim 8, wherein said stopping structure is a coupler.

10. The clamp assembly of claim 8, wherein said stopping structure is an anchor.

11. The clamp assembly of claim 8, wherein said stopping structure is a bolt.

12. The clamp assembly of claim 8, wherein said stopping structure is a screw.

13. The clamp assembly of claim 8, wherein said stopping structure is a pin.

14. The clamp assembly of claim 8, wherein said stopping structure is a rivet.

15. The clamp assembly of claim 1, wherein said clamping fastener further comprises a shaft inserted into a cavity of a ring, said ring is longitudinally positioned at the portion of said shaft defined by said expansion slot at said neutral position, said ring further restricting the lateral movement of said clamping fastener beyond said neutral position to a position in said expansion range.

16. The clamp assembly of claim 15, wherein said ring is an E-ring.

17. The clamp assembly of claim 15, wherein said ring is an O-ring.

18. The clamp assembly of claim 15, wherein said ring is a C-ring.

19. The clamp assembly of claim 15, wherein said ring is a D-ring.
